(19) United States
(12) Patent Application Publication
(10) Pub. No.: US 2008/0086496 A1
(43) Pub. Date: Apr. 10, 2008

(54) Communal Tagging

(76) Inventors: Amit Kumar, San Jose, CA (US); Priyank S. Garg, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/544,789

(22) Filed: Oct. 5, 2006

(51) Int. Cl. G06F 7/00

(52) U.S. Cl. 707/102

(57) ABSTRACT

A technique is provided for associating user-created tags with website communities. A website community comprises one or more websites that each comprise one or more webpages. In one approach, multiple users associate multiple tags with multiple webpages of different websites. Based on a first tag set that is associated with a first website and based on a second tag set that is associated with a second website, it is determined that the first and second websites are related and information is stored indicating such. In another approach, a user associates a particular tag with a webpage of a website. The user indicates that the particular tag is to be shared with other users that visit the website. When a second user requests a webpage from that website, a tag view is provided to the second user. The tag view includes the particular tag.

### FIELD OF THE INVENTION

The present invention relates generally to user tagging and, more specifically, to a technique for providing aggregate tag views of a website.

### BACKGROUND

A tag is a keyword or descriptive term associated with an item as a means of classification. Tags are usually chosen informally and personally by a user of the item. For example, a user discovers a webpage that discusses Indian cooking. The user creates a tag that associates one or more words with the webpage, such as “Indian cooking”. A tag does not have to be actual word; rather a tag may consist of any string of one or more characters that a user associates with a webpage.

Thus, tags are not usually part of a formally defined classification scheme. Tags are typically used in dynamic, flexible, automatically generated internet taxonomies for online resources such as computer files, web pages, digital images, and internet bookmarks. Some users use tags as an alternative to the “Bookmark” option provided by the major web browsers.

Typically, an item will have one or more tags associated with it, as part of an automated classification software or system. MyWeb (provided by Yahoo!) and Del.icio.us are popular social bookmarking sites that provide an automated classification system. The system provides links to other items which share that keyword tag, or even to specified collections of tags. This allows for multiple “browseable paths” through the items which can quickly and easily be altered by the collection's administrator, with minimal effort and planning.

Thus far, tagging has been “personal” in that tagging is directed towards end-users that are tagging items for their own use. Tagging is also directed towards other end-users who are able to use others' tags for their use (e.g. searching across all tags). To extend the “Indian cooking” example, the user-created tag is made public by allowing other users to search for websites or webpages that discuss “Indian cooking” and having the URL associated with the “Indian cooking” webpage appear in the search results. Thus, a user may discover related webpages on a per-tag basis. Also, a user may discover multiple tags that have been associated with a particular webpage.

However, no current mechanism takes advantage of information that indicates that although different tags have been associated with different webpages, the different webpages belong a single website. Such information may be used to provide services to assist users in their Web experience.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-E are block diagrams that illustrate deductions that may be made of the relationships between and among users, tags, and webpages, according to an embodiment of the invention;

FIG. 2 is a flow diagram that illustrates how a tag may be shared with a website community, according to an embodiment of the invention;

FIG. 3 illustrates an example of how a tag view may be displayed on a website, according to an embodiment of the invention;

FIG. 4 illustrates an example of the similarity between the set of tags associated with one website and the set of tags associated with another website, according to an embodiment of the invention;

FIG. 5 is a flow diagram that illustrates how similar websites may be discovered using tags, according to an embodiment of the invention;

FIG. 6 is a block diagram that illustrates an example of how similar websites may be discovered using tags, according to an embodiment of the invention;

FIG. 7 is a flow diagram that illustrates how a user's homepage may be adapted based on the tagging activity of the user, according to an embodiment of the invention;

FIG. 8 is a block diagram that illustrates an example homepage of a particular user, according to an embodiment of the invention;

FIG. 9 is a flow diagram that illustrates how the tagging activity of multiple Web users may assist other users in searching the Web, according to an embodiment of the invention;

FIG. 10 is a block diagram that illustrates an example of how the tagging activity of multiple Web users may assist other users in searching the Web, according to an embodiment of the invention; and

FIG. 11 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

The current tagging experience for Web users is primarily a personal one. If a user is interested in a webpage, then the user may “tag it” with keywords that make sense to the user. The set of all user-created tags may be managed by a tag database. If the tag database is made public, other users with similar interests might search the database on a per-tag basis and view webpages associated with one or more tags, and hence find interesting URLs. Some interesting deductions may be made of the relationships between and among users, tags, and webpages.

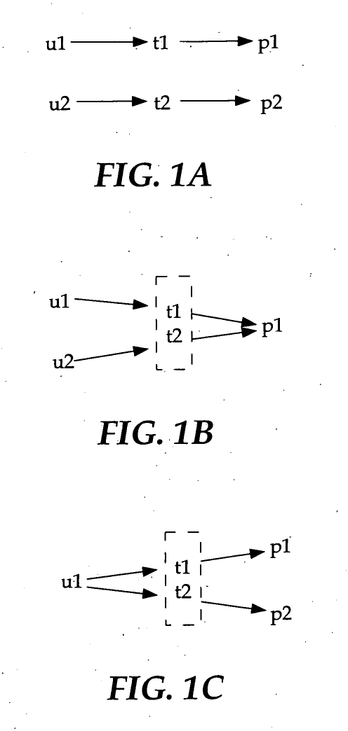

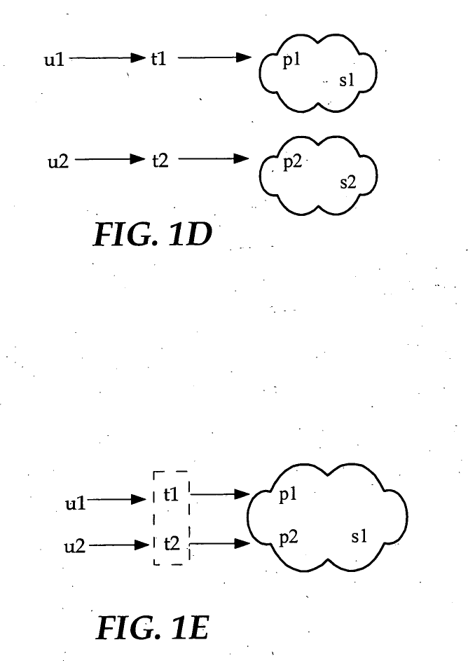

FIGS. 1A-E are block diagrams that illustrate some of these deductions. In FIG. 1A, user ‘u1’ associates a tag ‘t1’ with webpage ‘p1’. Also, user ‘u2’ associates a tag ‘t2’ with webpage ‘p2’. Other than the fact that users ‘u1’ and ‘u2’ are tagging webpages, no significant deduction can be made simply from this information.

In FIG. 1B, user ‘u1’ associates a tag ‘t1’ with webpage ‘p1’ and user ‘u2’ associates a tag ‘t2’ with webpage ‘p1’. Here, a relationship may be made between tags ‘t1’ and ‘t2’ because they have been associated with the same webpage.

In FIG. 1C, user ‘u1’ associates a tag ‘t1’ with webpage ‘p1’ and associates a tag ‘t2’ with webpage ‘p2’. Here, a relationship may be made between tags ‘t1’ and ‘t2’ because they are associated with the same user.

Another entity may become part of this relationship identification process: the website to which a tagged webpage belongs. To illustrate an example, in FIG. 1D, user ‘u1’ associates a tag ‘t1’ with webpage ‘p1’ of website ‘s1’, whereas user ‘u2’ associates a tag ‘t2’ with webpage ‘p2’ of website ‘s2’. Here, no significant deduction can be made regarding the tags, webpages, or websites because no entity is the same.

However, in FIG. 1E, user ‘u1’ associates a tag ‘t1’ with webpage ‘p1’ of website ‘s1’ and user ‘u2’ associates a tag ‘t2’ with webpage ‘p2’ of website ‘s1’. Here, a relationship may be made between t1 and t2 since they are associated with the same website, although with different webpages of the website. Typically, different webpages of the same website have similar content. For example, http://knitting.com/Oriental_Patterns will most likely have similar content as http://knitting.com/Indian_Patterns.

When multiple tags are associated with multiple webpages of a single website, a relationship between the multiple tags may be deduced and the multiple tags may represent the website as a whole. This information may be used by users to discover more information about a single website, discover similar websites, enhance the users' homepage experience, and assist in searching the Web.

### Definitions

A website is a collection of webpages, typically common to a particular domain name or subdomain on the World Wide Web on the Internet. A website is owned and/or managed by a single entity, such as an individual, a partnership, or a company. For example, the website (and each of the webpages on the same server) accessible at http://cnn.com is owned by CNN. As another example, the website (and each of the webpages on the same server) accessible at http://stanford.edu/˜amitk is managed by user amitk, although Stanford University may own the server that hosts the website. In this example, user amitk is said to be the owner/manager of the website accessible at http://stanford.edu/˜amitk.

A “website community” may refer to a single website or multiple websites that are related in some way. By extension, “users of a website community” refers to the users that visit a single website or related websites. For example, the users that visit http://cnn.com may be users of the CNN community. As another example, all websites that provide stories and information on major league baseball may be a major league baseball community.

A website community may be categorized as “implicit” or “explicit.” In either case, the website community in this sense refers to the users that frequent the website(s). An example of users of an implicit community is all users that visit http://cnn.com. Another example of users of an implicit community is all users that visit websites that provide information on the War of 1812. An example of users of an explicit community is all registered users of http://espn.com. Another example of users of an explicit community is all users that are required to pay a fee to view requested content of http://espn.com.

With respect to what makes websites related, multiple websites may be related in a variety of ways, such as being owned by a common website owner. Typically, however, it may be more helpful to think of multiple websites as being related in the type of content they provide. Thus, http://espn.com and http://mlb.com are related websites because they each provide stories and information about major league baseball.

With this knowledge of website communities, tags may be associated with a website community instead of just with a single webpage. Any member/user of the website community can use the tags that have been associated with the website community to their advantage. Such use may include searching for similar website communities or simply learning more about what other users think (through their tags) about a certain website community.

### Sharing Tags of a Website with the Website Community

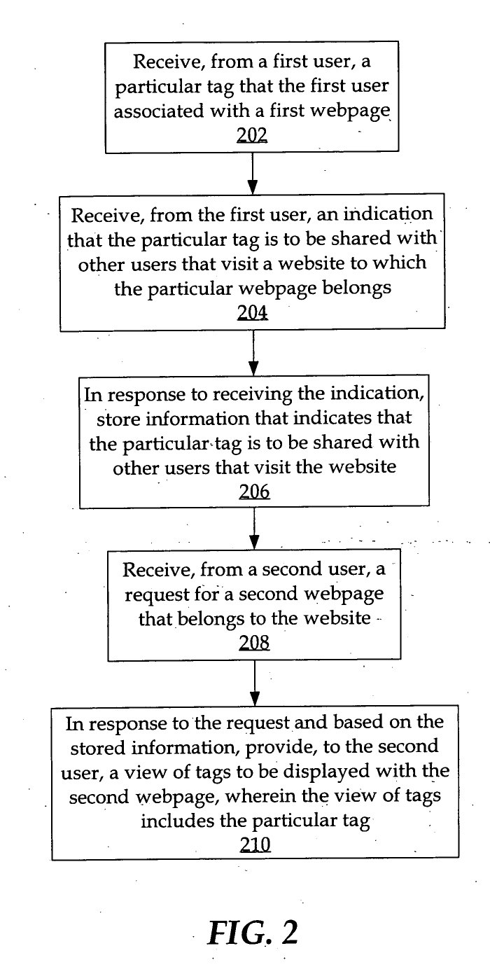

FIG. 2 is a flow diagram that illustrates how a tag may be shared with a website community, according to one embodiment of the invention. A first user creates a tag and associates the tag with a first webpage of a website. A “first webpage” is used to indicate any webpage of the website, not necessarily just the website's homepage.

At step 202, the tag is received from the first user. In one embodiment, the tag is received in response to the first user selecting a button (e.g., labeled “Tag This”) that is displayed with the first webpage. The button may be configured to display for any user that visits the website, only users that are registered with the website, or only users that have paid a fee. There may be other situations in which the button is configured to be displayed.

Upon selection of the button, the first user may be presented with a new window wherein the user can enter the tag information, including the description terms and, optionally, a URL if the user wishes to associate the tag with a different URL of the website. The new window may have an access options list that indicates which users are allowed to view the newly created tag. For example, access options may include (a) only the first user, (b) “friends” of the first user, (c) all visitors of the website, (d) registered users of the website, (e) everyone and any combination thereof. Thus, although the button is “located on” the first webpage, the tag may be contributed to a common pool of tags available to any Web user.

These access options correspond to ‘levels of trust’. For example, the first user might consider his/her friends an ‘inner circle’ and only allow them to view a certain set of tagging activity. As another example, the user might be willing to trust registered users of the website with their tagging activity, but not all users of the website.

At step 204, an indication is received from the first user that the particular tag is to be shared with other users that visit the website to which the first webpage belongs. This may be done when the first user selects, e.g., the “all visitors of the website” access option described above. In one embodiment, no such indication is received from the first user. Instead, the particular tag is automatically allowed to be shared with other users without “permission” from the first user. In that case, the above process would proceed from step 202 to step 208.

At step 206, in response to receiving the indication, information is stored that indicates that the particular tag is to be shared with other users that visit the website. However, embodiments of the invention do not require steps 204 and 206 to be performed. Instead, a tag may be automatically shared with all or at least some users of the website community.

In one embodiment, the information includes a weight given to the particular tag. The weight may influence how prominent the tag is displayed within a view of tags that is presented to a second user (see step 210) and/or when the particular tag should be displayed within the view of tags. For example, once the total weight of the particular tag (or related tags) passes a certain threshold, the particular tag (or related tags) will be displayed. The particular tag may be weighted based on many factors including, but not limited to: (a) whether the first user has registered with the website, (b) whether the first user has paid money to view content provided by the website owner, (c) whether the first user has been selected specifically by the website owner or webmaster of the website, (d) whether the first user has tagged one or more webpages of the website a certain number of times, (e) the amount of time the first user has been registered with the website, (f) whether and how often other users have selected other tags created by the first user, (g) the first user's established reputation according to a reputation system on the website or related websites, and (h) has otherwise satisfied particular criteria determined by the website owner or webmaster.

A “reputable” user is one deemed to have adequate reputation (either by absolute or relative measures to other users in a reputation system) to obtain certain special privileges. A “reputation system” is a system of developing an absolute or relative reputation (recorded, for example, as points or user attributes) of a user of a website, based on the evaluation of past activities or contributions of the user by website administrators or other users of the site. The system may incorporate other attributes such as longevity, frequency, level of service, etc. to affect the user's reputation.

At step 208, a request is received, from a second user, for a second webpage that belongs to the website. The second webpage may be the same as the first webpage or a different webpage of the website.

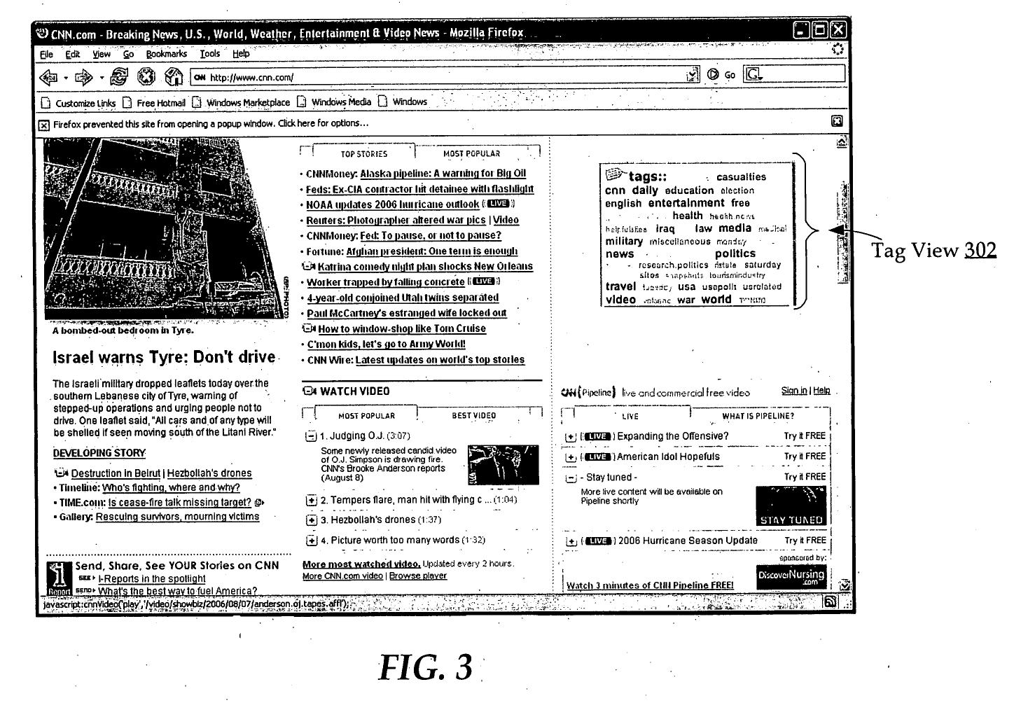

At step 210, in response to the request and based on the stored information, a view of tags is provided to the second user, where the view of tags includes the particular tag. The view of tags (or “tag view”) is to be displayed with the second webpage. FIG. 3 illustrates an example of how a tag view 302 may be displayed on a website, according to an embodiment of the invention.

The view of tags may be shown as a list or a “cloud.” The view of tags may be part of the second webpage, occupying its own space within the second webpage, or the view of tags may be an overlay, in which the tags are shown, e.g., when the second user “mouses-over” a part of the second webpage.

In one embodiment, the view of tags is displayed only to certain users. For example, the website owner may allow the view of tags to be displayed only to registered users.

In one embodiment, the tags that are displayed within the view of tags may be restricted, e.g., by a website owner. For example, a website owner may restrict the displayed tags to be those from only “reputable” users.

As another example, the second user is provided an options page that indicates options that the second user may select in order to limit the terms displayed in the view of tags. The options may include, but are not limited to, displaying user tags, displaying website-provided tags, displaying what a web crawler “thinks” of the website, and displaying only tags from “trusted” users. The options may include the option not only whether to display certain tags but whether to display certain tags differently. For example, tags from users who have paid money to view content of the website may be larger than tags from non-paying users. As another example, tags from users that have been registered with the website for over a certain amount of time may be bolded, whereas tags from all other users may not be bolded.

In one embodiment, the view of tags may initially be populated with “auto-tags” or terms that were not associated by users with any webpage of the website. When a website owner or webmaster first provides the ability for users to tag webpages of a website, there may not have been much user-tagging activity on the website. Therefore, the view of tags may be empty or only contain a few tags. A webmaster may decide to have auto-tags displayed until enough “real” (i.e., user-created) tags have been associated with webpages of the website. An auto-tag may include, but is not limited to, any of the following: terms specified by a webmaster of the website, anchor text of internal and/or external links to the website, or representative terms that a web crawler selects as describing a webpage of the website when it analyzes the webpage.

If a set of one or more auto-tags is based on anchor text and/or representative terms, then the set may change periodically since anchor text changes over time as well as the content of a website. Because a web crawler examines the Web periodically, the web crawler may detect these changes and update the set of auto-tags accordingly.

An auto-tag may be configured to be displayed differently than a user-created tag in order to distinguish between an auto-tag and a user-created tag. For example, the font type, font size, and/or color of an auto-tag may be different than a user-created tag.

One property of displaying a view of tags is that it is unlikely that a website owner will “tag spam” his/her own website (i.e., deliberately populating a tag view with deceptive tags in order to attract visitors). Spamming is used to attract users to visit a certain website. Because a user has to visit a website in order to see the tag view, there is no reason to include deceptive tags in the tag view. Furthermore, a tag view is to assist a user in navigating and learning about a website. If the tag view is not accurate or helpful to the user, then the user will likely not visit the website in the future. Thus, for at least these two reasons, it does not make sense for a website owner to “tag spam” his/her own website.

### Discovering Similar Websites

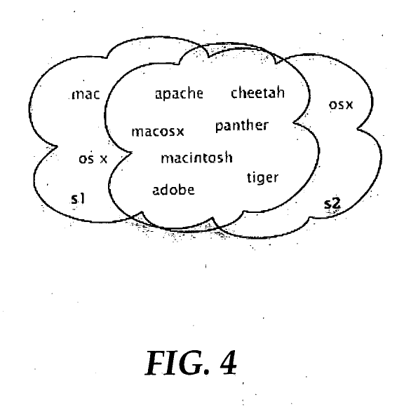

By accounting for the fact that tags may be associated with a particular website, such knowledge may be used to discover similar websites by comparing the tags that have been associated with each. FIG. 4 illustrates an example of the similarity between the set of tags associated with one website and the set of tags associated with another website, according to an embodiment of the invention. Based on this Venn diagram, seven of nine tags that have been associated with website ‘s1’ have also been associated with website ‘s2’. Furthermore, seven of eight tags that have been associated with website ‘s2’ have also been associated with website ‘s1’. Thus, websites ‘s1’ and ‘s2’ are very similar to each other. If a user discovers ‘s1’ by any method and is interested in its content, the user may also be interested in visiting ‘s2’.

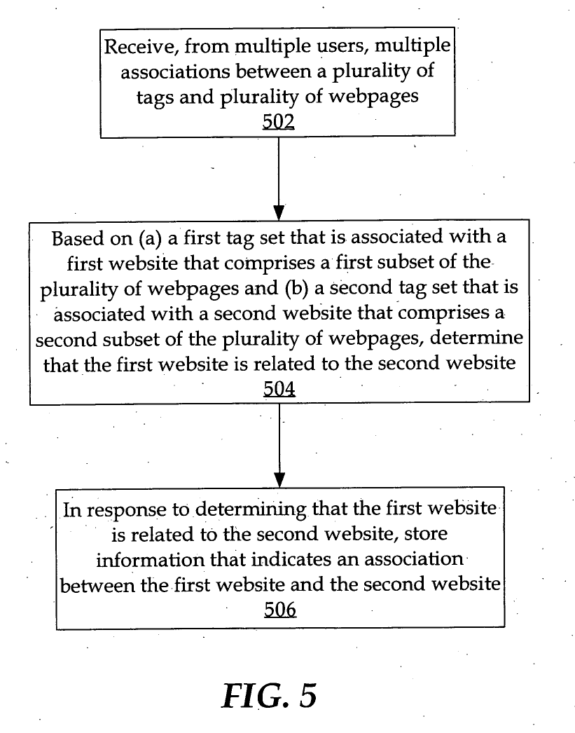

FIG. 5 is a flow diagram that illustrates how similar websites may be discovered using tags, according to an embodiment of the invention. At step 502, multiple associations between a plurality of tags and plurality of webpages are received from multiple users.

At step 504, based on (a) a first tag set that is associated with a first website that comprises a first subset of the plurality of webpages and (b) a second tag set that is associated with a second website that comprises a second subset of the plurality of webpages, it is determined that the first website is related to the second website. Such a determination may be based on statistical analysis of the co-occurrence of tags among websites. If two websites show greater co-occurrence of tags than the average co-occurrence of tags across any two random websites, then it may identify a stronger relationship. For example, if at least 30% of the tags associated with website A are also associated with website B and the average co-occurrence of tags across two random websites is 4%, then websites A and B are similar. As another example, the threshold percentage of tags may be 30% for each website (i.e., 30% of the tags associated with website B are also associated with website A).

In one embodiment, a tag set may be limited to tags only from certain users, such as “reputable” users discussed above.

In one embodiment, the determination is performed in response to receiving an indication from a user that the user desires to search for websites similar to the first website. For example, a user enters a query, such as “jaguar OS”, and submits the query to a search engine database. Results of the query indicate links to webpages or websites that may contain both the terms “jaguar” and “OS”. Adjacent to each result link, a link entitled “Similar Websites” may appear. Selecting the “Similar Websites” link adjacent to a particular search result is an indication that the user desires to search for websites similar to the website corresponding to the search result.

In one embodiment, the step of determining is performed in response to receiving an indication from a particular user that the particular user desires to limit a search query to websites similar to the first website and the search query is applied to the similar websites. This is known as a “vertical” search. For example, the search query “baseball” is entered by a user in a search query field along with the URL http://espn.com. The user may select a particular button, such as a “Vertical Search” button, that indicates to the search engine to limit the search only to websites that are similar to http://espn.com.

In one embodiment, the step of determining is performed in response to detecting that a particular user has visited one or more webpages of the first website and a link to the second website is provided to the particular user to be displayed. For example, suppose a user's browser contains a search toolbar associated with a search engine. When the user visits any website, the search engine may examine the tags that have been associated with the website and find websites similar to the visited website based on the tags. The search engine then provides to the search toolbar, to be displayed on the user's browser, a list (or view) of one or more websites that are similar to the visited website. If the user is interested in any of the provided similar websites, then the user may select a link to visit the website corresponding to the selected link.

At step 506, in response to determining that the first website is related to the second website, information is stored that indicates an association between the first website and the second website.

Although the first website may be similar to the second website, it does not necessarily follow that the second website is regarded as similar to the first website. For example, based on FIG. 4, if most of the tags associated with site ‘s1’ are also associated with site ‘s2’, then s2 will be considered as a site similar to ‘s1’. However, if there are many tags associated with website ‘s2’ that are not also associated with website ‘s1’, then website ‘s2’ is not similar to site ‘s1’ for the concepts represented by those tags. If these concepts represent a majority of the concepts of site ‘s2’, a reverse association between the second website and the first website may not be stored. Therefore, if a user begins at website ‘s2’, then website ‘s1’ may not be discovered as a similar website although a user may begin at website ‘s1’ and automatically discover website ‘s2’ as a similar website since the tags of website ‘s2’ include most of the tags of website ‘s1’.

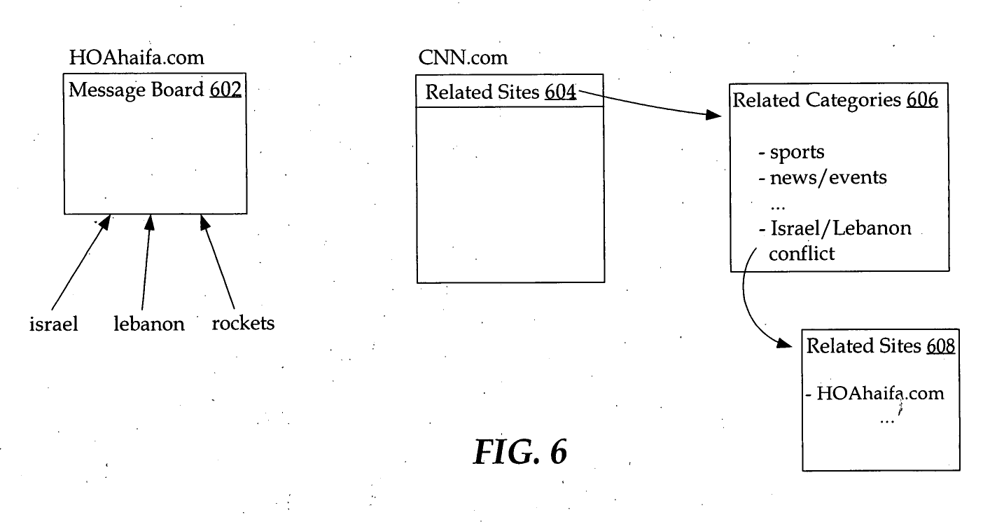

FIG. 6 is a block diagram that illustrates an example of how related websites may be discovered through tagging, according to an embodiment of the invention. A home owners association website in Haifa, Israel maintains a website (e.g., HOAhaifa.com) that comprises a message board 602 page that members of the community use to post and read messages from other community members. To illustrate the relative anonymity of the website, only a few messages are posted in a typical week and the message board 602 is not linked by any other searchable webpage. However, during a Middle East conflict, hundreds of users are tagging the message board 602 page, especially friends and relatives of the community members who are located in other countries to attain up-to-date information on the health and well-being of the community. Some tags being associated with HOAhaifa.com include “israel”, “lebanon”, and “rockets”.

A particular user then visits CNN.com (see FIG. 6). The browser of the particular user contains a toolbar (e.g., Yahoo! Toolbar) that includes a related sites 604 link or button. When the particular user selects related sites 604 when CNN.com is currently displayed in the browser, a list of categories that are related to the subject matter of CNN.com may be displayed, e.g., in a related categories 606 page. In this example, the categories displayed in related categories 606 page include “sports”, “news/events”, and “Israel/Lebanon conflict”. If the user is interested in websites that include information on the “Israel/Lebanon conflict”, then by selecting that category, a new page or window will appear (e.g., a related sites 608 page) that displays one or more websites relating to that category. Because many “israel” and “lebanon” tags have been associated with the message board of HOAhaifa.com, HOAhaifa.com will appear in the results of the related sites 608 page.

Without community members (and, e.g., relatives of community members) tagging the message board 602 page of HOAhaifa.com, many unrelated but interested users, such as those visiting CNN, would not have been able to discover HOAhaifa.com (other than by word-of-mouth).

### Homepage Experience

Many Web users have a homepage that they log into each day and which provides information tailored to the needs and/or interests of the user. A homepage (a) may be a page that a particular user has created for him/herself or (b) may be provided by a third party (e.g., My Yahoo!) that allows the homepage to be modified according to the interests of the user. For example, the homepage may provide weather information of the city in which the user lives. As another example, the homepage may provide search results of a daily query that the user wishes to submit. As yet another example, the homepage may contain a set of links to websites that the user visits frequently. By tracking the tagging activity of a user, a tagging database may provide information to the user's homepage to help further adapt the homepage to reflect the user's interests.

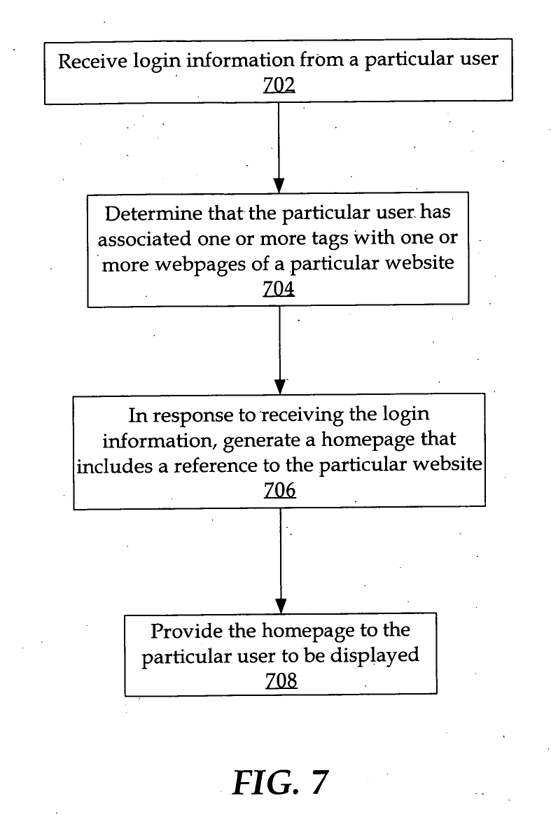

FIG. 7 is a flow diagram that illustrates how a user's homepage may be adapted based on the tagging activity of the user, according to an embodiment of the invention. At step 702, login information from a particular user is received. At step 704, it is determined that the particular user has associated one or more tags with one or more webpages of a particular website. At step 706, in response to receiving the login information, a homepage is generated that includes a reference to the particular website. At step 708, the homepage is provided to the particular user to be displayed.

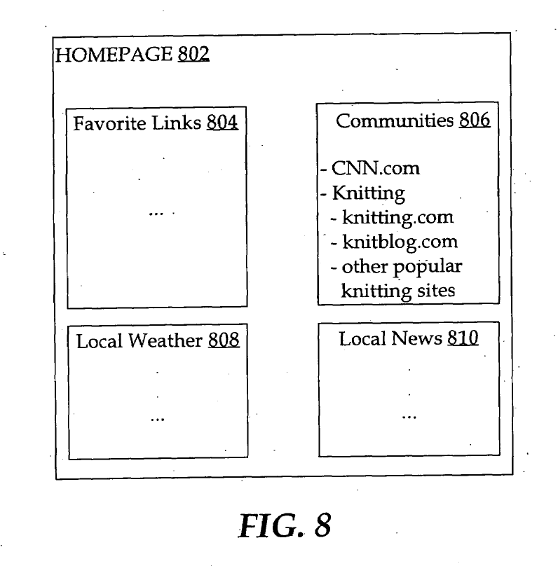

FIG. 8 is a block diagram that illustrates an example homepage 802 of a particular user, according to an embodiment of the invention. Homepage 802 is divided up into multiple sections. The sections may include a favorite links 804 section, a communities 806 section, a local weather 808 section, and a local news 810 section. Communities 806 section includes the communities to which the particular user belongs. The communities are determined based, at least in part, on the websites that the user tags and optionally on the websites that the user visits frequently. According to communities 806, the particular user is part of the CNN.com community and a knitting community that includes at least knitting.com and knitblog.com, indicating that the particular user has tagged these websites before.

The communities displayed in communities 806 may be of a single website and/or multiple related websites. For example, CNN.com is a single website community, whereas the “Knitting” community comprises at least two websites.

In one embodiment, a community in communities 806 may have a link associated with the community that, when selected, causes references to websites similar to the corresponding community to be displayed. For example, under the “Knitting” community in communities 806, a link to “other popular knitting sites” is listed. Selecting the link will cause a new page or pop-up window or frame to be generated and which displays knitting sites that share similar tags to the tags that have been associated with knitting.com and/or knitblog.com.

In one embodiment, the communities displayed in communities 806 may be ordered in some manner, such as the most frequently tagged communities, or the most recently tagged communities.

### Web Searching

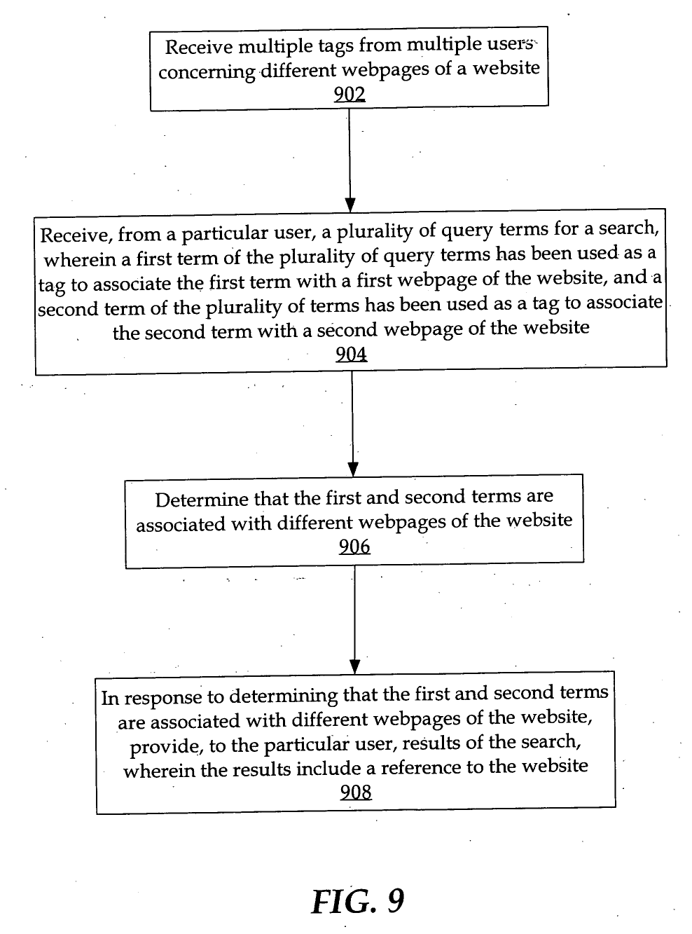

Associating tags with certain website communities may also assist Web users with searching the Web. FIG. 9 is a flow diagram that illustrates how the tagging activity of multiple Web users may assist other users in searching the Web, according to an embodiment of the invention. At step 902, multiple tags are received from multiple users concerning different webpages of a website.

At step 904, a plurality of query terms for a search are received from a particular user. A first term of the plurality of query terms has been used as a tag to associate the first term with a first webpage of the website. A second term of the plurality of terms has been used as a tag to associate the second term with a second webpage of the website. Other terms in the plurality of query terms may have been used as tags to associate the other terms with other webpages of the website.

At step 906, it is determined that the first and second terms are associated with different webpages of the website. At step 908, in response to determining that the first and second terms are associated with different webpages of the website, results of the search are provided to the particular user, wherein the results include a reference to the website.

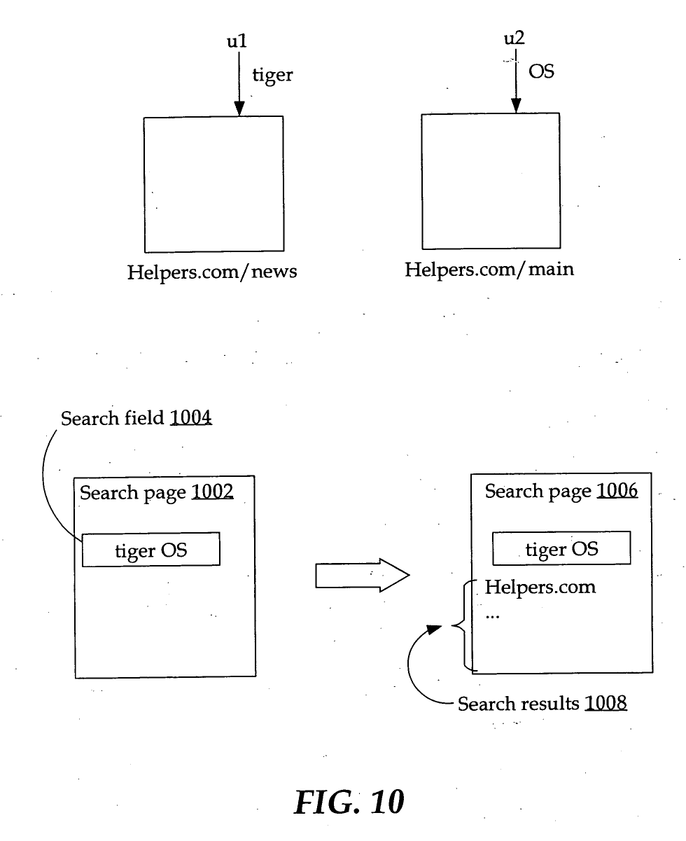

FIG. 10 is a block diagram that illustrates an example of how the tagging activity of multiple Web users may assist other users in searching the Web, according to an embodiment of the invention. User ‘u1’ tags the URL helpers.com/news with the word “tiger” and user ‘u2’ tags the URL helpers.com/main with the term “OS”. A third user requests to view a search page 1002 that contains a search field 1004 for entering query terms. The third user enters “tiger OS” as the plurality of query terms. Based on the knowledge that “tiger” has been associated with one webpage of helpers.com and that “OS” has been associated with another page of helpers.com, a search page 1006 is generated that contains search results 1008 based on the submitted query. Search results 1008 includes a reference to helpers.com.

By associating a tag with the appropriate website in addition to a webpage, such website-level queries may occur. Website-level queries presume that the multiple webpages of a website contain similar content.

### Hardware Overview

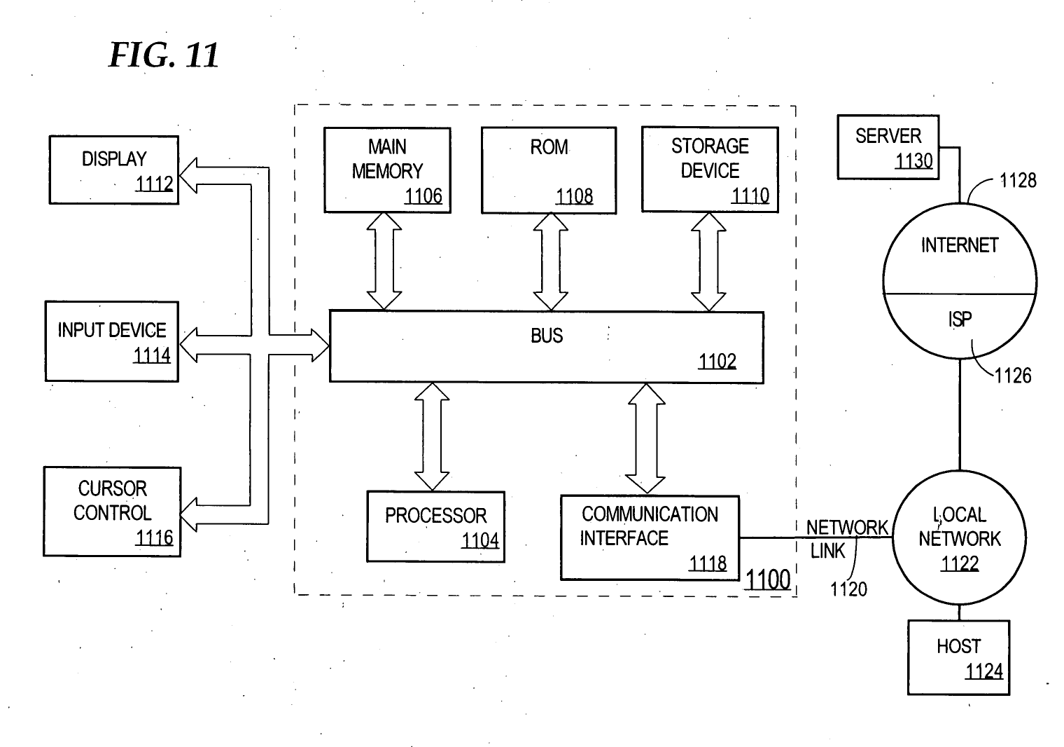

FIG. 11 is a block diagram that illustrates a computer system 1100 upon which an embodiment of the invention may be implemented. Computer system 1100 includes a bus 1102 or other communication mechanism for communicating information, and a processor 1104 coupled with bus 1102 for processing information. Computer system 1100 also includes a main memory 1106, such as a random access memory F (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

The invention is related to the use of computer system 1100 for implementing the techniques described herein. According to one embodiment of the invention, those techniques are performed by computer system 1100 in response to processor 1104 executing one or more sequences of one or more instructions contained in main memory 1106. Such instructions may be read into main memory 1106 from another machine-readable medium, such as storage device 1110. Execution of the sequences of instructions contained in main memory 1106 causes processor 1104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 1100, various machine-readable media are involved, for example, in providing instructions to processor 1104 for execution. Such a medium may take many forms, including but not limited to, non-volatile media, volatile media, and transmission media. Non-volatile media includes, for example, optical or magnetic disks, such as storage device 1110. Volatile media includes dynamic memory, such as main memory 1106. Transmission media includes coaxial cables, copper wire and fiber optics, including the wires that comprise bus 1102. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1104 for execution. For example, the instructions may initially be carried on a magnetic disk of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are exemplary forms of carrier waves transporting the information.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution. In this manner, computer system 1100 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
receiving, from a first user, a particular tag that the first user associated with a first webpage;
wherein the particular tag (a) is a set of one or more words that the first user associated with a Uniform Resource Locator (URL) and (b) describes content of a webpage that corresponds to the URL;
wherein the particular webpage belongs to a website;
receiving, from a second user who is separate from the first user, a request for a second webpage that belongs to said website; and
in response to said request, providing, to the second user, a view of tags to be displayed with said second webpage, wherein the view of tags includes the particular tag.

2. The method of claim 1, wherein:
receiving the particular tag from the first user includes receiving, from the first user, an indication that the particular tag is to be shared with other users that visit a website to which the particular webpage belongs;
storing information that indicates that the particular tag is to be shared with other users that visit said website is performed in response to receiving the indication; and
providing the view to the second user is based on the stored information.

3. The method of claim 1, wherein:
the particular tag is weighted differently than other tags in the view of tags; and
the particular tag is weighted based on at least one of the following factors: whether the first user is registered with said website, whether the first user has paid money to be registered with said website, the amount of time the first user has been registered with said website, whether and how often other users have selected other tags created by the first user, and the reputation of the first user.

4. The method of claim 1, wherein the view of tags is provided in response to detecting a mouse-over by the second user over a particular portion of the main webpage of said website.

5. The method of claim 1, wherein:
a portion of terms in the view of tags are not tags; and
the portion of terms are based on at least one of following: (1) keywords specified, as meta-data in one or more webpages of said website, by a webmaster of said website, (3) anchor text of links that link to one or more webpages of said website, and (4) analysis of said website by a web crawler for key concepts that said website is about.

6. The method of claim 1, wherein:
the first webpage includes a tag button which the first user selects; and
the method further comprising providing, to the first user, a new page to be displayed, wherein the new page includes a field into which the first user enters the particular tag.

7. The method of claim 1, wherein:
the method further comprises, providing an options page that indicates options that the second user may select to limit the terms displayed in the view of tags; and
said options include at least one of the following: display tags only, display terms provided by a webmaster of the website, and display trusted tags differently than non-trusted tags.

8. The method of claim 7, wherein trusted tags are tags that have been created by users who have done at least one of the following:
paid money to register with the said website;
registered with said website for a certain period of time;
tagged one or more webpages of said website a certain number of times; and
interacted with one or more webpages of the website to such an extent that a reputation system, associated with said website, identifies each of said users as reputable.

9. A method, comprising:
receiving, from multiple users, multiple associations between a plurality of tags and a plurality of webpages;
wherein each tag of said plurality of tags (a) is a set of one or more words that a user associated with a Uniform Resource Locator (URL) and (b) describes content of a webpage that corresponds to the URL;
based on (a) a first tag set that is associated with a first website that comprises a first subset of the plurality of webpages and (b) a second tag set that is associated with a second website that comprises a second subset of the plurality of webpages, determining that the first website is related to the second website; and
in response to determining that the first website is related to the second website, storing information that indicates an association between the first website and the second website.

10. The method of claim 9, wherein the step of determining is performed in response to receiving an indication from a particular user that the particular user desires to search for websites similar to the first website.

11. The method of claim 9, wherein:
the step of determining is performed in response to receiving an indication from a particular user that the particular user desires to limit a search query to websites similar to the first website; and
the search query is applied to the second website.

12. The method of claim 9, wherein:
the step of determining is performed in response to detecting that a particular user has visited one or more webpages of the first website; and
a link to the second website is provided to the particular user to be displayed.

13. A method, comprising:
receiving login information from a particular user;
determining that the particular user has associated one or more tags with one or more webpages of a particular website;
wherein each tag of the one or more tags (a) is a set of one or more words that the particular user associated with a Uniform Resource Locator (URL) and (b) describes content of a webpage that corresponds to the URL;
in response to receiving the login information, generating a homepage that includes a reference to the particular website; and
providing the homepage to the particular user to be displayed.

14. The method of claim 13, wherein the homepage also includes a link that, when selected, causes a new page to be displayed that displays websites similar to the particular website.

15. The method of claim 13, wherein:
the homepage includes a plurality of references to a plurality of websites;
the particular website is one of the plurality of websites;
the particular user has associated one or more other tags with each of the plurality of websites; and
the order of the plurality of references is based, at least in part, on one or more of the following: a number of tags that have been associated with each website of the plurality of websites, and which website of the plurality of websites was tagged most recently.

16. A method, comprising:
receiving multiple tags from multiple users concerning different webpages of a website;
wherein each tag of said tags (a) is a set of one or more words that a user associated with a particular Uniform Resource Locator (URL) and (b) describes content of a webpage that corresponds to the particular URL;
receiving, from a particular user, a set of query terms for a search, wherein each term of a plurality of the set of query terms has been used as a tag to associate said term with a separate webpage of said website;
determining that each term of said plurality is associated with different webpages of said website; and
in response to determining that each term of said plurality is associated with different webpages of said website, providing, to the particular user, results of the search, wherein the results include a reference to said website.

17. A method, comprising:
receiving, from a user, a tag of one or more words that the user associated with a Uniform Resource Locator (URL), wherein the tag describes content of a webpage that corresponds to the URL;
in response to receiving the tag, associating the tag with a particular website community that comprises one or more related websites, wherein the particular website community includes at least a website to which said webpage belongs; and
storing information that indicates the association.

18. A machine-readable medium carrying one or more sequences of instructions which, when executed by one or more processors, causes the one or more processors to perform the method recited in claim 1.

19. A machine-readable medium carrying one or more sequences of instructions which, when executed by one or more processors, causes the one or more processors to perform the method recited in claim 2.

20. A machine-readable medium carrying one or more sequences of instructions which, when executed by one or more processors, causes the one or more processors to perform the method recited in claim 3.

21. A machine-readable medium carrying one or more sequences of instructions which, when executed by one or more processors, causes the one or more processors to perform the method recited in claim 4.

22. A machine-readable medium carrying one or more sequences of instructions which, when executed by one or more processors, causes the one or more processors to perform the method recited in claim 5.

23. A machine-readable medium carrying one or more sequences of instructions which, when executed by one or more processors, causes the one or more processors to perform the method recited in claim 6.

24. A machine-readable medium carrying one or more sequences of instructions which, when executed by one or more processors, causes the one or more processors to perform the method recited in claim 7.

25. A machine-readable medium carrying one or more sequences of instructions which, when executed by one or more processors, causes the one or more processors to perform the method recited in claim 8.

26. A machine-readable medium carrying one or more sequences of instructions which, when executed by one or more processors, causes the one or more processors to perform the method recited in claim 9.

27. A machine-readable medium carrying one or more sequences of instructions which, when executed by one or more processors, causes the one or more processors to perform the method recited in claim 10.

28. A machine-readable medium carrying one or more sequences of instructions which, when executed by one or more processors, causes the one or more processors to perform the method recited in claim 11.

29. A machine-readable medium carrying one or more sequences of instructions which, when executed by one or more processors, causes the one or more processors to perform the method recited in claim 12.

30. A machine-readable medium carrying one or more sequences of instructions which, when executed by one or more processors, causes the one or more processors to perform the method recited in claim 13.

31. A machine-readable medium carrying one or more sequences of instructions which, when executed by one or more processors, causes the one or more processors to perform the method recited in claim 14.

32. A machine-readable medium carrying one or more sequences of instructions which, when executed by one or more processors, causes the one or more processors to perform the method recited in claim 15.

33. A machine-readable medium carrying one or more sequences of instructions which, when executed by one or more processors, causes the one or more processors to perform the method recited in claim 16.

34. A machine-readable medium carrying one or more sequences of instructions which, when executed by one or more processors, causes the one or more processors to perform the method recited in claim 17.
